(19) United States
(12) Patent Application Publication
(10) Pub. No.: US 2006/0031285 A1
(43) Pub. Date: Feb. 9, 2006

(54) Internet-based on-demand digital program delivery system and method

(75) Inventors: William Ruhnke, Brooklyn, NY (US); Lowell Feuer, Englewood, NJ (US)

Correspondence Address: SILLS CUMMIS EPSTEIN & GROSS P.C., ONE RIVERFRONT PLAZA, IP DEPARTMENT, NEWARK, NJ, 07102, US

(73) Assignee: KlikVu, Inc.

(21) Appl. No.: 11/159,284

(22) Filed: Jun. 22, 2005

Related U.S. Application Data
(60) Provisional application No. 60/521,794, filed on Jul. 4, 2004.

(51) Int. Cl. G06F 15/16

(52) U.S. Cl. 709/203

(57) ABSTRACT

A method of providing video and/or audio on-demand service to owners of video and/or audio program rights for offering digital versions of the programs to web site visitors. The method is an Application Service Provider (ASP) model, whereby the services are provided to owners over the World Wide Web and no specific software need reside with the owners. Video and/or audio programs from the owners, once converted to an appropriate digital form, are streamed over the Internet or other IP networks for viewing in real-time, direct from a remote device having servers that store the digital programs, to viewers who have purchased the right to view them. The sales transaction is conveyed to the owner, and the digital programs are streamed to the viewer from the remote servers on behalf of the owner. E-commerce transaction processing is provided on behalf of the owner, and revenue is conveyed to the owner.

This application claims the benefit of provisional application No. 60/521,794, filed on Jul. 4, 2004, the contents of which are incorporated herein by this reference.

### BACKGROUND OF THE INVENTION

1. Field of the Invention

The present invention relates to on-line services for consumers, and more specifically, to a system and method of providing on demand digital video and audio programs to visitors on a particular web site.

2. Prior Art

Currently, web sites that offer video and/or audio over the Internet must first acquire the rights to provide such exhibition from the video and/or audio content owner or rights holder. This limits the catalog of video and/or audio offerings and a web site's ability to acquire exhibition rights. Such rights may require verification and documentation, which may be an expense and a risk for the web site, as exhibition rights may be challenged by others who participated in the making of the video and/or audio. Some video and/or audio content may not have a proper paper trail to allow verification of rights, yet the content owner may be confident that they do have all necessary rights for Internet exhibition.

Currently Amazon.com® provides a central directory of available books, and other outside web sites may feature listings of books, where such listings initiate a transaction with Amazon.com®. When a customer uses Amazon.com® through an ordering web site, Amazon.com® forwards the customer to an Amazon.com® branded web page, to which the customer may return in the future without the ordering web site. Therefore, competition is a problem for the third party web site with the methods of the prior art.

Similarly, Car-part.com® provides a central database and e-commerce transaction system used by junk yards to list their auto parts inventory, and each junk yard's web site draws just their own listings from the database. Current content syndication services for web sites, such as ScreamingMedia.com®, collect a fee from the web site that displays the content.

Video and/or audio content owners that have video and/or audio files or programs that they wish to provide over the Internet on a pay-per-view basis and collect fees from viewers, can either build their own pay-per-view e-commerce billing, authentication, and media serving solution using a combination of outside service providers and in house development, or they can provide their video and/or audio programs to a web site that already has the pay-per-view e-commerce and video and/or audio hosting service in place, such as Atom Films® or CinemaNow®. Thus, the content provider has to acquire software or pay a retainer to a hosting services provider, and has to transfer exhibition rights to a video and/or audio web site, which implicates legal issues.

Currently, peer-to-peer distribution methods, such as Bitorrent®, Grokster® or Streamcast®, provide members the opportunity to list their video and/or audio files available for delivery, and those files reside with the member and are delivered from there. Napster® maintained a central database of listings, which each user could add to, and which was parsed or filtered based on search criteria. However, Napster® provided delivery directly from a user's computer. Moreover, these peer-to-peer services display all listings of files which meet the buyer's search criteria, regardless of from which web site the buyer originates.

There are several music-on-demand web sites that list digitized music files which they hold, sell, and deliver on behalf of the musician. These services take the transaction directly at their own web site. Current music-on-demand delivery systems, like the Amazon.com® model described above, clearly identify themselves in the transaction as the reseller. Therefore, these web sites must also assume the legal responsibilities along with the rights to the video and/or audio from the owners of the video and/or audio.

### SUMMARY OF THE INVENTION

Therefore, it is an object of the present invention to provide a method and system where the owners of the video and/or audio do not have to transfer rights to the video and/or audio to the web sites, and the web sites do not have to undertake the legal responsibilities involved with selling the video and/or audio files.

The present invention provides one or more databases containing entries which constitute listings of video and/or audio files that are available to the invention to provide to web visitors. Selected listings are made available to be displayed on different web sites, or in response to different search criteria. A web visitor may choose a listing to order and retrieve the video and/or audio file on-line. Multiple web sites can be served by one or more centralized databases, with each web site obtaining a customized listing of database entries. Selected entries from the database(s) are provided to a particular web site where they are offered to web site visitors for viewing. Web sites may use their own database or listing techniques, and incorporate code that would place a transaction through the centralized database.

The video and/or audio contents (or other media assets) are encoded into digital files, stored on servers, and listed in the database on behalf of the video and/or audio owner. Ordering of the video or audio programs can be accomplished on-line, through one or a number of web sites that use the invention to process transactions that permit the web visitor to obtain access to the video and/or audio and retrieve the video and/or audio over the Internet or other IP-type network.

The actual transaction by the web visitor to obtain the video and/or audio for viewing is consummated on behalf of the video and/or audio owner. The present invention provides transaction, storage, and delivery services to the video and/or audio owner. The ordering web site provides marketing services to the video and/or audio owner. The legal rights in regard to the delivery or exhibition of the video and/or audio remain with the buyer and seller.

The present invention allows web sites to provide marketing services to the video and/or audio owner (the seller), act as a syndication outlet for the seller's video and/or audio programs, and generate sales of video and/or audio files. The invention provides for on-line delivery of the video and/or audio file, either downloaded or streamed, and provides an accounting of the sale and delivery. Web sites participate either as ordering sites or as referrers. Ordering web sites display database entries directly and allow actual ordering of the video and/or audio files. Referrer web sites direct web visitors to pages at the appropriate ordering web site to view database entries and order video and/or audio programs.

Accordingly, a system for providing digital on-demand content to be offered on a web site is provided, the system comprising a directory of one or more available digital files provided on a website and stored on one or more remote servers, ordering means to order one or more particular digital files, transaction processing means to accept orders placed by a customer for the one or more particular digital files, and delivering means for delivering the one or more particular digital files from the one or more remote servers to the customer.

Further, a method for providing digital on-demand content to be offered on a web site is provided, the method comprising providing a listing to a customer of available video and/or audio files stored on one or more remote servers and selected from a directory based on a variety of search or filter criteria on a web site, generating an order form on the web site for the customer, accepting orders placed by the customer on the web site for a particular video and/or audio file, and granting the customer viewing or retrieval privileges to the particular video and/or audio file, where the particular video and/or audio file is viewed or retrieved from the one or more remote servers for the customer.

The above and other features of the invention, including various novel details of construction and combinations of parts, will now be more particularly described with reference to the accompanying drawing and pointed out in the claims. It will be understood that the particular device embodying the invention is shown by way of illustration only and not as a limitation of the invention. The principles and features of this invention may be employed in various and numerous embodiments without departing from the scope of the invention.

### BRIEF DESCRIPTION OF THE DRAWING

These and other features, aspects, and advantages of the apparatus and methods of the present invention will become better understood with regard to the following description, appended claims, and accompanying drawing where:

FIG. 1 is a schematic flowchart that illustrates the steps of the method of the present invention.

### DETAILED DESCRIPTION OF THE INVENTION

Although this invention is applicable to numerous and various types of online transactions, it has been found particularly useful in the environment of sales, distribution and exhibition of on-demand video and/or audio files and programs. Therefore, without limiting the applicability of the invention to the above, the invention will be described in such environment.

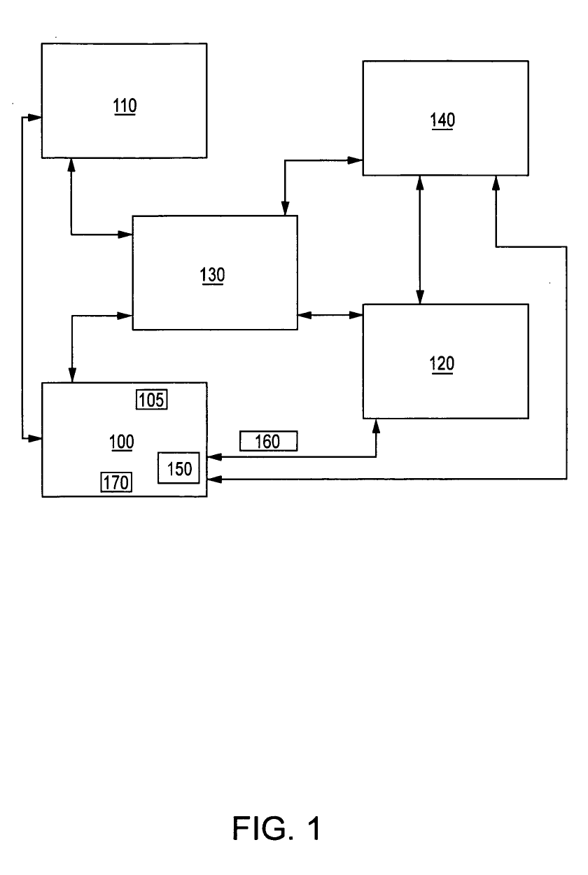

FIG. 1 illustrates a schematic representation of a digital video and/or audio delivering method and system in accordance with the present invention. An owner 110 of a video and/or audio program or file that wishes to sell or otherwise show that video and/or audio on the Internet provides a digital file version of the video and/or audio to be stored on a remote server. The owner 110 sends the video and/or audio files to a device 100. An online order form (not shown) may be generated for the owner 110 to fill out with the necessary information prior to providing the rights to view the video and/or audio to the device 100. This order form could release the device 100 or web site 130 from any liability.

The files may be digitized by the device 100 if the files are not in digital form. The device 100 comprises remote servers that are not owned or operated by a web site 130, that store the video and/or audio programs or files. Thus, access to the video and/or audio comes under the control of the device 100. Alternatively, the owner 110 can send the video and/or audio files to the web site 130, who forwards it on to the device 100, along with a completed marketability questionnaire.

The device 100 reviews the video and/or audio content to see if it has adequate commercial potential. If so, the device 100 notifies the owner 110 and/or the website 130 of its willingness to provide server hosting, e-commerce transactions, and digital rights management/anti-piracy security.

From the video/audio servers 105 of the device 100, web users 120 can view or otherwise retrieve the video and/or audio file(s). A customer 120 visiting the web site 130 can request a listing of the video and/or audio files by clicking the appropriate link on the web site 130. The availability of the video and/or audio for viewing is cataloged in one or more centralized databases. The databases are stored in the device 100 which presents listings 160 of the web site's video and/or audio programs. The web site 130 can customize the appearance of the listings 160.

The web site 130 may offer particular video and/or audio programs to its visitors. These selected entries in the database(s) are displayed by the web site 130 to the customer 120. The customer 120 can see a listing 160 of the selected entries, and then choose one or more entries to obtain the video and/or audio file for viewing and/or listening. The customer 120 can search for a particular file, a group of files categorized by a certain category, or can view the entire listing 160 of the video and/or audio files. The customer 120 can also view these listings 160 by visiting a referral web site 140 instead of the web site 130, such as by way of links on the referral web site's page. Each video and/or audio listing includes a “Buy Now” button.

If the customer 120 decides to purchase the video and/or audio file(s), the customer clicks on the “Buy Now” button or through some other means to purchase the video and/or audio file(s). An order page or order form 150 (or appropriate HTML code) is provided for the web site 130 to display to the customer 120, and the customer 120 can interact with the device's shopping cart 170. The device's billing system can maintain customer session and cookies to recognize returning customers.

The device 100 then charges the customer's credit card, or any other type of payment means can be used by the customer to purchase the video and/or audio files. The transaction is electronically processed on behalf of the owner 110. The device then delivers the video and/or audio file to the customer 120 by streaming the video and/or audio to the customer 120 from the servers 105 of the device 100.

The owner 110 is notified of the transaction with the customer 120. Revenue collected from the customer 120 can be distributed to cover costs, and the revenue can be divided appropriately between the parties, including the web site 130, any referral web site 140 that may have directed the customer 120 to the ordering web site 130 and thereby earned a commission, and the owner 110.

The present invention provides several advantages that solve the problems with prior art methods. The present invention provides a business model and method for providing video and/or audio on-demand service to owners of video and/or audio programs to offer digital versions of those programs to web site visitors. It is a method for using the World Wide Web to select and display database records of digital video and/or audio files that are available for retrieval over the Internet, and to publish the display to client web sites, such that visitors to that web site can choose to obtain or view, as may be permitted by the video and/or audio owner, the video and/or audio file, which is then delivered in digital format over the Internet, on behalf of the video and/or audio owner.

The method and apparatus function as an Application Service Provider (ASP), such that the client web site 130 need not install their own database or record retrieval and search functions, or e-commerce type functions for executing an order, but can avail themselves of the shared database (device 100) and its functions, including a user interface to accept an order, and to appear on the web site 130 as if the web site operated their own database and e-commerce system.

The method and apparatus further provides conditional access to video and/or audio files which are named in the database records, and may be integrated with e-commerce or membership functions to permit the visitor to access one or a group of video and/or audio files. The method further stipulates that the video and/or audio files listed in the database are listed on behalf of the video and/or audio owner. Upon granting a web site visitor 120 access to a video and/or audio file(s), the device 100 provides an accounting of such access to the video and/or audio owner 110. This provides a filmmaker-direct-to-viewer marketplace.

The device 100 also provides for a billing means with transactional capabilities which include the ability to share revenue with client web sites 130 to encourage the web site to offer the video and/or audio files. Pricing for paid user access to the video and/or audio files can be set according to a number of different criteria, including dynamic pricing set by mathematical formulas which may include self negotiating market mechanisms and auction models. The device 100 through the billing means can also pay a referral fee to referral web sites 140.

The present invention allows the content owner 110 to market their video and/or audio programs on their own volition, and to accept any risk or liability of possible rights disputes, so the web sites 130 do not have to. The transaction is completed by actual digital conveyance of the video and/or audio ordered, over the Internet. Further, the transaction, while executed by the device 100, maintains the appearance that the sale is placed with the ordering web site 130, and consummated with the video and/or audio rights owner 110. The device 100 does not take orders directly, and therefore does not interfere or compete with ordering web sites 130.

The invention uses a shared database system to list digital multimedia assets that can be delivered directly over the Internet. Whereas other Internet web sites may provide a list of items owned by individual companies on whose web sites the listings appear, the present invention may provide listings and ordering capabilities to appear on other web sites, where the web site is not the content owner and is not the seller. Each web site 130 may add database listings that are displayed solely on that web site 130, but the listings the web site 130 submits for the invention would typically be for items owned by others. The web site 130 only needs to display the database listing of the item for sale, and the invention actually delivers the purchased digital media files on behalf of the owner 110. The web site 130 does not need to own the inventory or actually fulfill the order.

The invention can also have customizable metadata, such as criteria for matching content to websites. Prior art metadata typically describes the title, the artist or principal actors, the year made, and one or two lines about the story, if applicable. The present invention provides customizable metadata that describes thematic, point-of-view, subject matter and other esoteric references triggered by the film or video property. These metadata references will be further customized to be accessible by web video search engines and targeted websites. Usually, the filmmaker or owner themselves, who knows the film most intimately, will do the first part of the customization. But the curator, or showcase webmaster, can perform the secondary customization.

The invention also provides for contextual syndication, where there is a syndication of videos to search engines and websites whose natural audience has a native interest in the themes of the video being searched, and therefore will be more likely to purchase a viewing of that video or other videos in a related theme. Contextual syndication allows for the aggregation and categorization of the content by the device 100, and the device 100 matches the most relevant videos and/or music with the users, depending on specific user preferences. Advertisements can be sold based on this contextual reference. The invention syndicates content to web sites 130 without any fee to the web site 130. The content syndicated is premium content for which a viewer must pay, and a portion of that payment is taken by the invention, in lieu of a fee.

The invention is unique because video and/or audio content owners 110 can use the invention's pay-per-view e-commerce software and the video and/or audio hosting service, without the owner 110 having to acquire software or pay a retainer to a hosting services provider, and without transferring exhibition rights to a video and/or audio web site 130.

The invention is also unique in that affiliate/referral sites 140 can forward web visitor traffic to another intermediary web site 130, which in turn relays the sale to the owner 110, yet does not require the owner 110 to become involved in fulfillment, as fulfillment is provided by the device 100 on behalf of the owner 110. The invention is not a reseller, but is a broker.

The present invention likewise provides member web sites 130 the capability to display listings of video and/or audio files available for delivery over the network, but the files themselves are delivered from one or more central servers that are under the control of the device 100. The device 100 only listings of video and/or audio files on the web site 130 for which the originating web site 130 is previously authorized to market.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

What is claimed is:

1. A system for providing digital on-demand content to be offered on a web site, the system comprising:
a directory of one or more available digital files provided on a website and stored on one or more remote servers;
ordering means to order one or more particular digital files;
transaction processing means to accept orders placed by a customer for the one or more particular digital files; and
delivering means for delivering the one or more particular digital files from the one or more remote servers to the customer.

2. The system for providing digital on-demand content to be offered on a web site according to claim 1, further comprising:
purchasing means for the customer to purchase the one or more digital files.

3. The system for providing digital on-demand content to be offered on a web site according to claim 1, further comprising:
billing means for providing revenue to the owner and the web site based on amounts or percentages the owner and the web site are to receive.

4. The system for providing digital on-demand content to be offered on a web site according to claim 1, further comprising:
sending means for an owner of the digital files to send the digital files to the one or more remote servers.

5. The system for providing digital on-demand content to be offered on a web site according to claim 1, further comprising:
one or more centralized databases where the one or more digital files are catalogued.

6. The system for providing digital on-demand content to be offered on a web site according to claim 1, further comprising:
searching means for the customer to search for a particular digital file or a group of digital files from the digital files stored on the remote servers.

7. The system for providing digital on-demand content to be offered on a web site according to claim 1, further comprising:
notification means for notifying an owner of the digital files of the order placed by the customer.

8. The system for providing digital on-demand content to be offered on a web site according to claim 1, wherein the one or more digital files are video files.

9. The system for providing digital on-demand content to be offered on a web site according to claim 1, wherein the one or more digital files are audio files.

10. The system for providing digital on-demand content to be offered on a web site according to claim 1, wherein the one or more digital files are video and audio files.

11. A method for providing digital on-demand content to be offered on a web site, the method comprising:
providing a listing to a customer of available video and/or audio files stored on one or more remote servers and selected from a directory based on a variety of search or filter criteria on a web site;
generating an order form on the web site for the customer;
accepting orders placed by the customer on the web site for a particular video and/or audio file; and
granting the customer viewing or retrieval privileges to the particular video and/or audio file, where the particular video and/or audio file is viewed or retrieved from the one or more remote servers for the customer.

12. The method for providing digital on-demand content to be offered on a web site of claim 11, the method further comprising:
providing purchasing means to the customer to purchase the one or more digital files.

13. The method for providing digital on-demand content to be offered on a web site of claim 11, the method further comprising:
providing revenue to the owner and the web site based on amounts or percentages the owner and the web site are to receive.

14. The method for providing digital on-demand content to be offered on a web site of claim 11, the method further comprising:
sending the one or more digital files from an owner of the digital files to the one or more remote servers.

15. The method for providing digital on-demand content to be offered on a web site of claim 11, the method further comprising:
cataloging the digital files stored on the one or more remoter servers into one or more centralized databases.

16. The method for providing digital on-demand content to be offered on a web site of claim 11, the method further comprising:
searching for a particular digital file or a group of digital files from the digital files stored on the remote servers.

17. The method for providing digital on-demand content to be offered on a web site of claim 11, the method further comprising:
notifying an owner of the digital files of the order placed by the customer.
